(19) United States
(12) Patent Application Publication
(10) Pub. No.: US 2010/0102524 A1
(43) Pub. Date: Apr. 29, 2010

(54) Shade Wagon

(76) Inventors: Jennie Colleen Larsen, Payson, UT (US); Nicole Marie Ramirez, Rayson, UT (US)

Correspondence Address: Malone Intellectual Property, 4390 N. 250 E., Provo, UT, 84604, US

(21) Appl. No.: 12/580,089

(22) Filed: Oct. 15, 2009

Related U.S. Application Data
(60) Provisional application No. 61/107,701, filed on Oct. 23, 2008.

(51) Int. Cl. B62B 3/02; B62B 11/00

(52) U.S. Cl. 280/35; 280/47.35

(57) ABSTRACT

An all purpose recreational wagon is set forth. The wagon generally includes adult seating with a centered accessory shaft for anchoring the wagon and supporting various accessories. At least one side of the wagon breaks off or hinges to allow for seating or table top functionality. The wagon can store two large coolers, stadium chairs and blankets, an umbrella, a stroller, an inverter, and other various items.

### PRIORITY CLAIM

This application claims priority to provisional application 61/107,701 filed Oct. 23, 2008, which is herein incorporated by reference.

### BACKGROUND

The field of the invention relates generally to wagons, and, more particularly, to a shade wagon having at least one hinged side panel that provide multiple seating and storage configurations in the wagon. The wagon also includes a centered accessory anchoring shaft for anchoring the wagon to the ground and for supporting various wagon accessories.

A standard children's wagon generally consists of a wagon body having a horizontally disposed surface or floor for supporting a child and upstanding front, rear and side walls formed around the periphery of this surface. Four wheels are attached to the bottom of the body and a handle is typically attached to either the front of the wagon body or to a pivoting bolster to which the front wheels of the wagon are attached.

In the past, wagon bodies and handles have been formed of wood, metal or combinations thereof. Recently, however, wagon bodies and handles have been made from molded plastic, such as polyethylene or some similar material. Such wagons are becoming increasingly popular because of their light weight, durability, corrosion resistance, lower manufacturing cost and safety.

Constructing wagon bodies from molded plastic also provides for greater flexibility in terms of product design. For example, additional storage spaces, seating and other interior features may be molded into the wagon body. An example of such a wagon is presented in U.S. Pat. No. 6,318,740 to Nappo and U.S. Pat. No. 6,932,365 to Chiappetta et al.

The Nappo '740 patent illustrates a plastic wagon with a storage space molded into the bottom of its body with a removable panel that separates the storage space from the passenger space of the wagon. Coolers are also formed on the front and rear ends of the wagon. When the panel is removed, the storage space serves as a foot well for a pair of passengers facing one another with the coolers serving as back rests. The passengers sit on the portions of the passenger space floor that remain after the panel is removed. A disadvantage of the wagon of the Nappo '740 patent is that the removable panel, when not in use, must be stored. In additional to taking up storage space, it may become lost. Furthermore, the wagon of the Nappo '740 patent only features two interior configurations.

The Chiappetta et al. '365 patent illustrates a wagon having a storage space molded in the bottom of the plastic body. A pair of panels are attached within the interior of the wagon in a hinged fashion. When the panels are opened into generally vertical orientations, they form seatbacks for a pair of opposing seats so that children may sit in the wagon facing one another. The exposed storage space serves as a foot well for the wagon passengers. When the panels are closed into generally horizontal orientations, they cover the storage space so as to provide the interior of the wagon with a flat floor.

While the wagon of the Chiappetta et al. '365 wagon is versatile and does not feature panels that may become separated from the wagon and lost, additional interior configurations are still desirable. A shade wagon that offers multiple seating and storage configurations would provide increased convenience and utility.

### SUMMARY OF THE INVENTION

It has been recognized that it would be advantageous to develop a wagon with a centered anchor for anchoring wagon to the ground.

It has been recognized that it would be advantageous to develop a wagon with a centered accessory shaft for securing and storing wagon accessories.

It has been recognized that it would be advantageous to develop a wagon with at least one side that folds down allowing the base of the wagon to be used as two adult sized chairs.

It has been recognized that it would be advantageous to develop a wagon with an umbrella positioned on a centered accessory shaft.

It has been recognized that it would be advantageous to develop a wagon with built-in speakers.

It has also been recognized that it would be advantageous to develop a wagon capable of carrying greater than 500 pounds of cargo.

It has also been recognized that it would be advantageous to develop a wagon capable of being towed by a vehicle.

It has also been recognized that it would be advantageous to develop a wagon with a fold down table.

It has also been recognized that it would be advantageous to develop a wagon with at least one break away side.

It has also been recognized that it would be advantageous to develop a wagon with one or more adult type stadium seats.

It has also been recognized that it would be advantageous to develop a wagon with under-drawers for storing items.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a side view of a shade wagon in accordance with an embodiment of the present invention;

FIG. 2 is a side view of a shade wagon in accordance with an embodiment of the present invention;

FIG. 3 is a perspective view of a shade wagon in accordance with an embodiment of the present invention;

FIG. 4 is a perspective view of a shade wagon in accordance with an embodiment of the present invention;

FIG. 5 is a perspective view of a shade wagon in accordance with an embodiment of the present invention;

FIG. 6 is a side view of a shade wagon in accordance with an embodiment of the present invention;

FIG. 7 is a side view of a shade wagon in accordance with an embodiment of the present invention;

FIG. 8 is a side view of a shade wagon in accordance with an embodiment of the present invention;

### DETAILED DESCRIPTION OF EXAMPLE EMBODIMENT(S)

Description

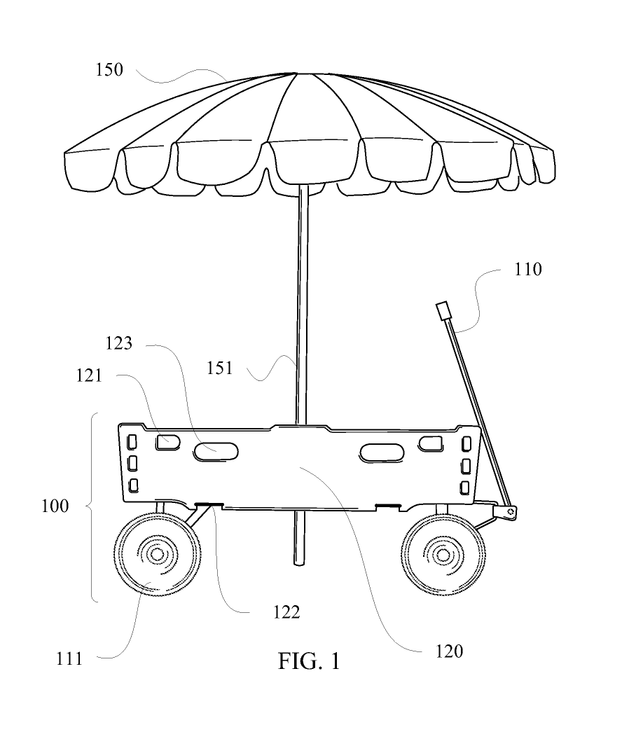

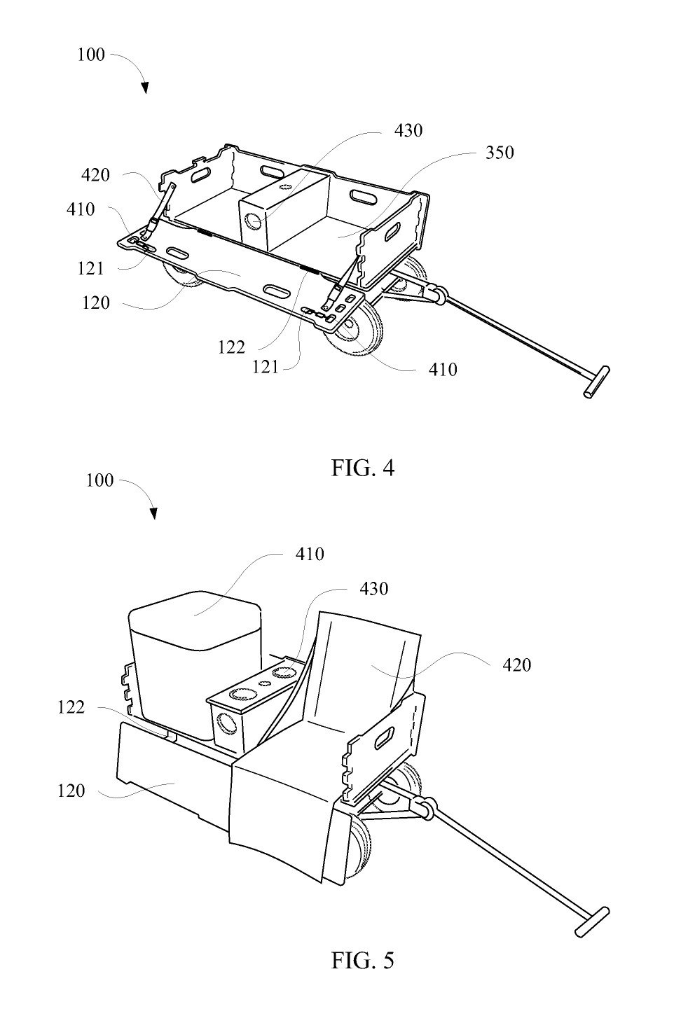

As illustrated in FIG. 1, shade wagon (100) has a side (120) including at least one hinge (122), four tires (111), a centered accessory shaft (151), an umbrella (150), handles (123) and accessory holes (121). The centered accessory shaft (151) may be fitted with a number of accessories including: an umbrella, a cooking device, a light, drink holders, a cloths line, a luggage rack, a rack for lawn or garden accessories, a hook, or any other device that may provide added utility to wagon (100). Pivoting side (120) is shown in an upright position (first position). The pivoting side (120) has utility in at least three distinct positions: the upright position shown in FIG. 1, the horizontal position shown in FIG. 4, and the inverted position shown in FIG. 5. Accessory shaft (151) is shown in travel position, meaning that the accessory shaft is not anchored into the ground.

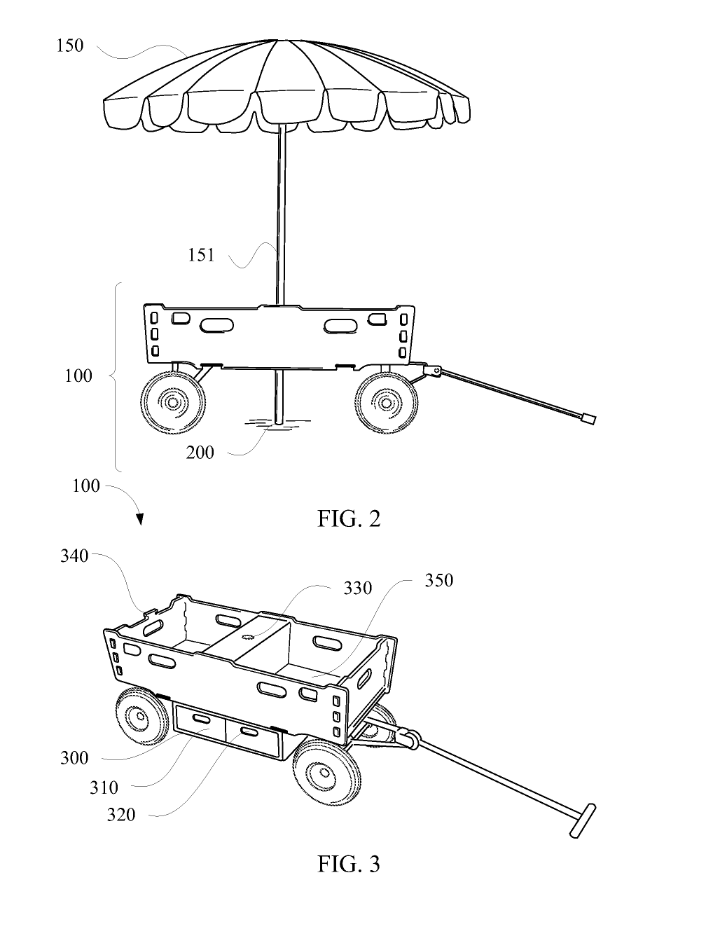

FIG. 2, shows accessory shaft (151) anchored into the ground (200).

FIG. 3, shows under-drawers (310) positioned directly below the wagon base (350).

FIG. 4 shows pivoting side (120) in a horizontal position with straps (420) adjusted so as to allow side (120) to be used as a table top. Accessory hole (430) may contain a speaker or other accessory such as an inverter, a thermal electric cooler, an mp3 player or the like.

FIG. 5 shows stadium seating (420) positioned to allow comfortable adult seating within wagon. Pivoting side (120) is shown in an inverted position allowing for comfortable seating. The pivoting side (120), when in the inverted position, provides protection and support to a persons legs from the tires of the wagon. An optional cooler (410) may be positioned in wagon. Accessory storage (430) may include an inverter, a DC battery, a speaker, an MP3 player, a thermal electric cooler, or any other known accessory useable in conjunction with a recreational or utility wagon.

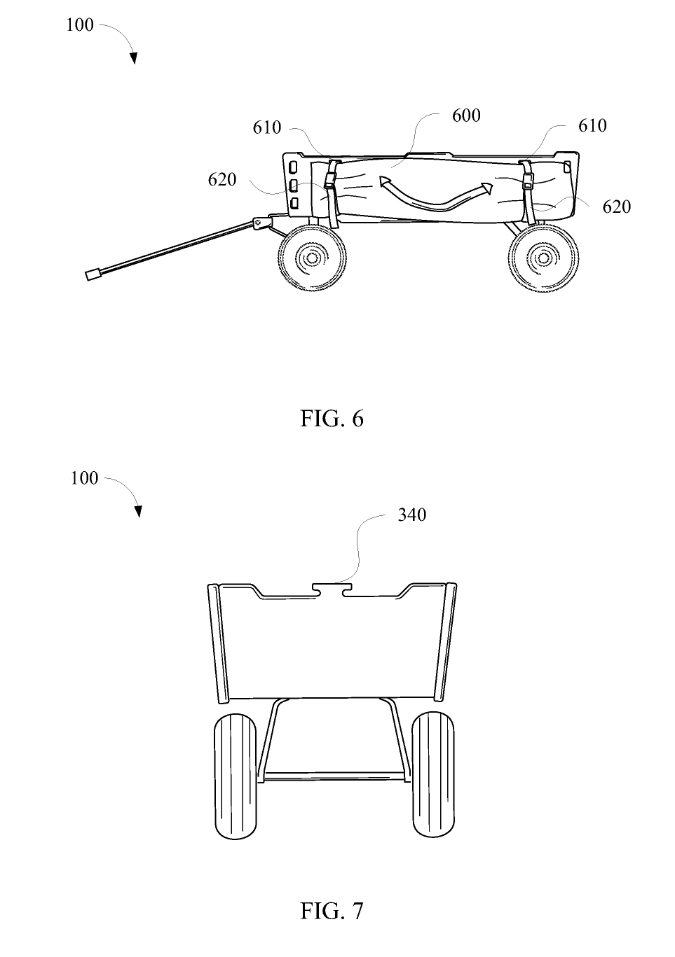

FIG. 6 shows accessory straps (620) attached a side of the wagon by being feed through accessory holes (610). Accessory (600) is attached by accessory straps (620). Accessory (600) may be an umbrella or stroller or any other wagon accessory previously mentioned.

FIG. 7 shows an accessory hook (340) on the rear section of the wagon. Accessory hook (340) may be used to hold a trash bag or other like item.

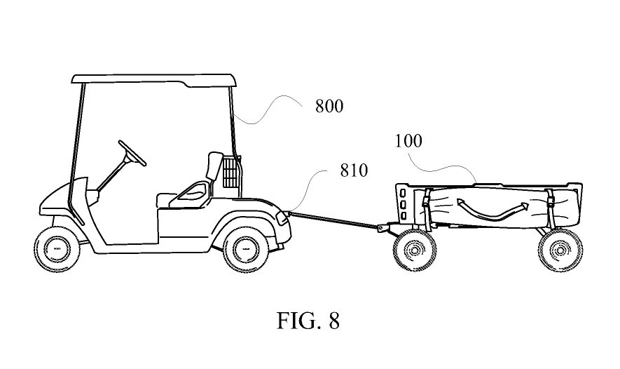

FIG. 8 shows a vehicle (800) towing wagon (100). Vehicle (800) may be any type of vehicle including a car, golf cart, or electric car.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A wagon comprising:
a) a body supported by a plurality of wheels, said body including a front wall, a rear wall, opposing side walls and a bottom so that an interior is defined;
b) at least one of the opposing side walls being pivotally attached to the bottom constituting at least one pivoting side wall; and
c) a centered accessory shaft extending completely through the bottom of the wagon.

2. The wagon of claim 1 wherein the at least one pivoting side wall has functional utility in at least three pivoting positions.

3. The wagon of claim 2 wherein the at least one pivoting side wall includes a means for securing said at least one pivoting side wall in said at least three pivoting positions.

4. The wagon of claim 1 wherein said centered accessory shaft supports an umbrella.

5. The wagon of claim 1 wherein said centered accessory shaft supports a laundry rack.

6. The wagon of claim 1 wherein said centered accessory shaft supports garden tools.

7. The wagon of claim 1 wherein said centered accessory shaft supports a cooking grill.

8. The wagon of claim 1 wherein said centered accessory shaft supports a volleyball net.

9. The wagon of claim 1 wherein said centered accessory shaft supports luggage.

10. The wagon of claim 1 wherein the bottom of the wagon body also serves as top for under-drawer storage.

11. The wagon of claim 1 wherein the rear wall includes an accessory hook.

12. The wagon of claim 1 wherein the opposing side walls include accessory holes.

13. The wagon of claim 1 further comprising a cup holder positioned within the interior of the wagon.

14. The wagon of claim 1 further comprising a speaker attached to the wagon.

15. The wagon of claim 1 wherein said body is constructed of plastic.

16. A wagon comprising:
a) a body supported by a plurality of wheels and featuring an interior;
b) a side panel attached to the body in a pivoting fashion; and
c) an adjusting means for adjusting said side panel into multiple positions.

17. The wagon of claim 16 wherein the side panel is attached to the body by means of a break-away hinge.

18. The wagon of claim 16 further comprising a battery and an inverter located within said interior.

19. A wagon comprising:
a) a body supported by a plurality of wheels;
b) a side panel attached to the body in a pivoting fashion;
c) an adjusting means for adjusting said first panel into multiple positions; and
d) a center console located within the body, the center console including a centered accessory hole extending completely through the center console and the body of the wagon.

20. The wagon of claim 19 wherein the side panel features a pair of side edges and said wagon body includes a pair of bores and further comprising a pair of pins positioned one each on the side edges of said side panel, each of said pins independently engaging one of the bores.
